(19) United States
(12) Patent Application Publication
(10) Pub. No.: US 2009/0199926 A1
(43) Pub. Date: Aug. 13, 2009

(54) HYDROGEN FUELING

(76) Inventors: Wilfried-Henning REESE, Unterschleissheim (DE); Harald KRAUS, Munich (DE)

Correspondence Address: The BOC Group, Inc., 575 MOUNTAIN AVENUE, MURRAY HILL, NJ, 07974-2082, US

(21) Appl. No.: 12/364,920

(22) Filed: Feb. 3, 2009

(30) Foreign Application Priority Data
Feb. 7, 2008 (DE) 102008007928.6

(51) Int. Cl. F17C 5/06; G05D 16/00

(52) U.S. Cl. 141/4; 62/50.2; 141/18; 137/14; 137/255

(57) ABSTRACT

A method for filling a storage tank with gaseous, pressurized hydrogen where a) liquid hydrogen, which is extracted from a storage tank, is compressed to an average pressure and is stored intermediately in a buffer tank; b) the boil-off gas accumulating in the storage tank is compressed and is stored intermediately in the buffer tank; c) a pressure compensation between the storage tank, which is to be filled, and the buffer tank is carried out initially for filling the storage tank and d) hydrogen from the buffer tank is compressed subsequently to the desired storage pressure and is supplied to the storage tank wherein this compression of the hydrogen and the compression of the boil-off gas are realized by means of one compressor or by means of two compressors.

### CROSS REFERENCE TO RELATED APPLICATION

This application claims priority under 35 USC §119 to German Patent Application 102008007928.6 filed in the German Patent and Trademark Office on Feb. 7, 2008.

### BACKGROUND OF THE INVENTION

The invention relates to a method for fueling a storage tank with gaseous, pressurized hydrogen.

Generic methods for filling a storage tank with gaseous, pressurized hydrogen are used in particular in response to the filling of motor vehicle storage tanks for pressurized hydrogen.

So far, there are substantially three different methods, which are realized for filling a storage tank with gaseous, pressurized hydrogen.

Pressure compensation method: A plurality of gas buffer tanks are hereby filled with different pressure levels from a hydrogen supply system—this can be a tank or a storage tank, respectively, or a pipeline—by means of a compressor or by means of a cryogenic pump. A filling of a (motor vehicle) storage tank from these gas buffer tanks is carried out in that the hydrogen is filled into the storage tank between the gas buffer tanks and the storage tank by means of pressure compensation until the final fueling pressure has been reached.

Booster method: The required production capacity of the hydrogen is in turn filled directly into the (motor vehicle) storage tank from a hydrogen supply system by means of a compressor.

In practice, combined systems consisting of both of the afore-described methods are used as well. When using these combined systems, a partial filling of the storage tank is initially carried out by means of pressure compensation from the gas buffer tanks, before a filling of the storage tank to the desired final pressure is subsequently carried out using the booster method.

The afore-described methods for filling a storage tank comprising gaseous, pressurized hydrogen make it possible to fill storage tanks up to a pressure of 700 bar at 15°. The problem with this method, however, is that the filling processes cannot always be realized without an undesired overfilling and/or overheating of the storage tank in response to different volumes of the (motor vehicle) storage tanks, which are to be filled.

It is the object of the instant invention to specify-a generic method for filling a storage tank with gaseous, pressurized hydrogen, which makes this possible and which is furthermore optimized energetically. Furthermore, it is to be possible to avoid losses of hydrogen as much as possible.

### SUMMARY OF THE INVENTION

To solve this object, a method for filling a storage tank with gaseous, pressurized hydrogen is proposed, where
a) liquid hydrogen, which is extracted from a storage tank, is compressed to an average pressure and is stored intermediately in a buffer tank,
b) the boil-off gas accumulating in the storage tank is compressed and is stored intermediately in the buffer tank,
c) a pressure compensation between the storage tank, which is to be filled, and the buffer tank is carried out initially and
d) hydrogen from the buffer tank is compressed subsequently to the desired storage pressure and is supplied to the storage tank,
e) wherein this compression of the hydrogen and the compression of the boil-off gas are realized by means of one compressor or by means of two compressors.

In practice, the use of only one compressor for the compression of the hydrogen as well as of the boil-off gas will be realized in particular when the compressor, which is used, can handle the different pressure levels on its intake and outlet side. Provided that this is not the case or due to other considerations, it is also possible to provide for two compressors, which are designed for the different pressure levels.

Further advantageous embodiments of the method according to the invention for filling a storage tank with gaseous, pressurized hydrogen, which form the object of the dependent patent claims, are characterized in that
the average pressure comprises a pressure range between 100 and 600 bar, preferably between 200 and 450 bar,
the compression of the hydrogen, which is extracted from the storage tank, is carried out by means of a cryogenic piston pump,
only as much hydrogen is extracted from the storage tank and is compressed for the buffer tank to be filled to 90%, preferably to 80%, whereby a sufficient storage capacity can be ensured for the boil-off gas,
the storage of the liquid hydrogen takes place in at least one vacuum-insulated storage tank and
the storage tank, which is to be filled, is a mobile storage tank, in particular the storage tank of a motor vehicle, of a rail mounted vehicle or of an aircraft.

### DETAILED DESCRIPTION OF THE INVENTION

The method according to the invention for filling a storage tank with gaseous, pressurized hydrogen requires the supply and provisioning, respectively, with liquid hydrogen. For this, said liquid hydrogen is typically stored intermediately in a vacuum-insulated storage tanks. For a plurality of reasons, this provisioning seems to be the most sensible solution in response to the quantity scenarios at hydrogen filling stations, which are planned for the future:
So far, a hydrogen pipeline network, by means of which the sufficient quantities of hydrogen can be provided on location, does not exist.
The storage of gaseous hydrogen on location is not advantageous, as the space requirement is too great.
Fluctuations in the purchase quantities can be compensated for in the most flexible manner by means of a corresponding logistics concept, which is adapted to the well proven logistics concept of the petroleum industry.

According to the invention, liquid hydrogen, which is extracted from a storage tank, is now compressed to an average pressure and is stored intermediately in one or also in a plurality of buffer tanks. The compression of the hydrogen, which is extracted from the storage tank, hereby preferably takes place by means of a cryogenic piston pump. Presently, cryogenic piston pumps, which enable a compression up to a pressure of 450 bar, can be realized. The term “average pressure” is to be understood as a pressure range of between 100 and 600 bar, preferably of between 200 and 450 bar. A large part of the compression work is carried out using the method according to the invention in an energetically advantageous manner by means of hydrogen in liquid form. The energy demand of such a liquid compression is only approximately 20% of the energy demand of a hydrogen compression.

The hydrogen, which is compressed in such a manner, is stored intermediately in one or also in a plurality of buffer tanks. The provision of a plurality of buffer tanks, which are at different pressure levels, is referred to as a so-called banking system.

Advantageously, only as much hydrogen is extracted from the storage tank and is compressed for the buffer tank or the buffer tanks to be filled to 90%, preferably to 80%. It is ensured therewith that compressed boil-off gas can also be stored intermediately in the buffer tank or in the buffer tank.

A so-called boil-off behavior is to be considered with all cryogenic systems consisting of storage tank(s), pump(s), etc.. This means that liquid hydrogen is evaporated by means of incident heat from the environment onto the cryogenic system. Due to the considerably larger expansion of the gas, this causes a pressure increase in the cryogenic system. To avoid this, this gas, which is identified as boil-off gas, must be discharged from the system. As a rule, the storage tank thus encompasses a line, which leads into the atmosphere via a chimney, and via which the boil-off gas is blown off once a certain pressure value has been reached. This method, however, causes this portion of the stored hydrogen to be lost without being used.

According to the invention, the boil-off gas accumulating in the storage tank is now also compressed and is stored intermediately in the buffer tank or in the buffer tanks. The compressor required for doing so is preferably designed in such a manner that it automatically compresses the boil-off gas when a certain and adjustable pressure value, respectively, has been reached.

To fill a storage tank, a pressure compensation now takes place initially according to the invention between the storage tank, which is to be filled, and the buffer tank. If a banking system is used, which as a rule encompasses three buffer tanks, the hydrogen is filled consecutively from the low-pressure, the average-pressure and the high-pressure buffer tank into the (motor vehicle) storage tank, which is to be filled.

To avoid an overheating of the storage tank, which is to be filled, due to the negative Joule-Thompson effect and due to the adiabatic compression of the hydrogen, the gaseous hydrogen is pre-cooled to a temperature of approximately −40° C. immediately prior to the filling. Preferably, this takes place by using an active cooling system. As a rule, a control furthermore ensures a quantity limitation of the hydrogen flow-through so that the pressure difference between the buffer tank and the buffer tanks, respectively, and the (motor vehicle) storage tank, which is to be filled, never becomes so large that a maximum mass flow is exceeded.

After the filling of the (motor vehicle) storage tank from the buffer tank or the buffer tanks, a storage tank pressure of between 350 and 450 bar is reached as a rule, wherein said storage tank pressure ultimately depends on the fill level of the buffer tank or the buffer tanks.

Henceforth, the filling of the (motor vehicle) storage tank to the desired final pressure takes place according to the invention in that the hydrogen from the buffer tank or the buffer tanks is compressed to the desired final pressure and is supplied to the storage tank, which is to be filled. According to the invention, this compression of the hydrogen is realized by means of the same compressor, which serves the purpose of compressing the boil-off gas. This method has the advantage that a single compressor can undertake the task of two compressors. So as to make this possible in practice, the compressor must be integrated into the method according to the invention such that a preferably automatic switch-over between its two work tasks can be realized as a function of the current task requirement.

It is problematic hereby that the performance data of the two work tasks are different. In the case of the compression of the boil-off gas, the intake pressure is from 0 to 12 bar, the compression output is from 20 to 100 m³/h and the final compression pressure is approximately 300 bar. The compression of the hydrogen originating from the buffer tank or the buffer tanks, which is to be performed in the second fueling step, presently encompasses the following performance data: intake pressure to 300 bar, compression output from 1200 to 2000 m³/h, final compression pressure 875 bar at a temperature of 85° C.—this corresponds to a pressure of 700 bar at a temperature of 15° C.

Due to the fact that, in response to the same geometric compression volumes (compression chamber) and in response to a 10 to 20-fold inlet pressure, the flow-through quantity correspondingly increases tenfold to twentyfold, the compressor used for the method according to the invention is designed in such a manner that it is capable of handling the low as well as the high pressure level on its inlet and outlet side.

If the method for filling a storage tank with gaseous, pressurized hydrogen according to the invention is realized in a hydrogen filling station, said method enables an efficient operation, in particular in a transition period, in which a comparatively low number of vehicles per filling station are supplied. In response to a low number of vehicles, it is thus not (yet) necessary to “cool” the cryogenic pump, which is provided for the compression of the liquid hydrogen, which is extracted from the storage tank. The term “to cool” is to be understood hereby to define that the cryogenic pump is cooled to an operating temperature of −253° C. by means of liquid hydrogen and that this temperature is maintained. Due to the low compression quantities, the compressor, which is to be provided, is sufficient to fill these vehicles. If the number of vehicles increases, the cryogenic pump is cooled and then performs the main compression work by means of large throughputs.

As compared to the state of the art, the method for filling a storage tank with gaseous, pressurized hydrogen according to the invention encompasses a plurality of advantages, which are listed briefly below:
high throughputs
energetically advantageous, cryogenic compression
no boil-off gas losses
small space requirement due to compressors of small design
only volumetrically relatively small buffer containers are required due to high production capacities
high flexibility with reference to draw-off quantities and utilization concepts, in particular due to combined cryogenic pumps/compressor solution
system redundancy is present, because operation can be carried out via the compressor using lower volume flows in response to the breakdown or maintenance of the cryogenic pump and operation can be carried out by means of the pump in response to the breakdown of the compressor; filling can thus take place at least up to an average pressure of approximately 400 bar.

What we claim is:

1. A method for filling a storage tank with gaseous, pressurized hydrogen, wherein
a) liquid hydrogen, which is extracted from a storage tank, is compressed to an average pressure and is stored intermediately in a buffer tank,
b) the boil-off gas accumulating in the storage tank is compressed and is stored intermediately in the buffer tank,
c) a pressure compensation between the storage tank, which is to be filled, and the buffer tank is carried out initially and
d) hydrogen from the buffer tank is compressed subsequently to the desired storage pressure and is supplied to the storage tank,
e) wherein this compression of the hydrogen and the compression of the boil-off gas are realized by means of one compressor or by means of two compressors.

2. The method according to claim 1, characterized in that the average pressure comprises a pressure range of between 100 and 600 bar, preferably between 200 and 450 bar.

3. The method according to claim 1, characterized in that the compression of the liquid hydrogen, which is extracted from the storage tank, is carried out by means of a cryogenic piston pump.

4. The method according to claim 1, characterized in that only as much hydrogen is extracted from the storage tank and is compressed for the buffer tank to be filled to 90%, preferably to 80%.

5. The method according to claim 1, characterized in that only as much hydrogen is extracted from the storage tank and is compressed for the buffer tank to be filled to 90%.

6. The method according to claim 1, characterized in that only as much hydrogen is extracted from the storage tank and is compressed for the buffer tank to be filled to 80%.

7. The method according to claim 1, characterized in that the storage of the liquid hydrogen takes place in at least one vacuum-insulated storage tank.

8. The method according to claim 1, characterized in that the storage tank, which is to be filled, is a mobile storage tank.

9. The method according to claim 8, characterized in that the mobile storage tank is selected from the group consisting of the storage tank of a motor vehicle, the storage tank of a rail mounted vehicle and the storage tank of an aircraft.
